(19) United States
(12) Patent Application Publication
(10) Pub. No.: US 2019/0154644 A1
(43) Pub. Date: May 23, 2019

(54) CHROMATOGRAPH INPUT DEVICE AND CHROMATOGRAPH

(71) Applicant: Shimadzu Corporation, Kyoto (JP)

(72) Inventors: Yuki KOMORI, Kyoto (JP); Momoyo YAMAKAWA, Kyoto (JP)

(73) Assignee: Shimadzu Corporation, Kyoto (JP)

(21) Appl. No.: 16/314,456

(22) PCT Filed: Aug. 4, 2016
(86) PCT No.: PCT/JP2016/072912

§ 371 Date: Dec. 31, 2018

(51) Int. Cl. G01N 30/86; G06F 3/0488

(52) U.S. Cl. CPC G01N 30/8637; G06F 3/0488; G01N 30/8641

(57) ABSTRACT

A storage stores information of a peak start point, a peak end point, a peak top, and a boundary point and a boundary line between consecutive peaks of a chromatogram, as peak information. The selection processing unit selects the peak information or any peak included in the chromatogram based on the location of a touch gesture to the chromatogram displayed on a display monitor. This configuration contributes to preventing information different from information intended by an operator from being accidentally recognized when the operator makes a touch gesture to a touchscreen display monitor displaying the chromatogram. A correct input signal corresponding to the touch gesture on the touchscreen can thus be transmitted.

### TECHNICAL FIELD

The present invention relates to a chromatograph input device that transmits an input signal relating to a chromatogram displayed on a display, and a chromatograph.

### BACKGROUND ART

A chromatograph usually includes a detector, a data processor for processing various kinds of data, and a display. Such a chromatograph has the data processor creating a chromatogram based on a detection signal from the detector, and the chromatogram is displayed on the display.

The chromatograph further includes an input device that transmits an input signal to the data processor in response to operation of the input device by an operator. The data processor processes various kinds of data based on the input signal (for example, see Patent Document 1).

The gas chromatograph described in Patent Document 1 includes a mouse and a keyboard as input devices. With the display displaying a chromatogram, an operator operates the mouse to move a mouse pointer (a cursor) on the display and operates the keyboard to make a necessary input.

### CITATION LIST

### Patent Document

PATENT DOCUMENT 1: Japanese Patent No. 5206504

### SUMMARY OF THE INVENTION

### Technical Problem

Conventional gas chromatographs described as above may sometimes fail to transmit a correct input signal corresponding to an input operation, depending on the type of input device.

For example, with a conventional gas chromatograph having a touchscreen as the input device, an operator makes an input by selecting and touching a certain part on the touchscreen. The part touched by the operator is not a point but a region having a certain area. The touchscreen recognizes a certain point included in the touched part (touched region) as information selected by the operator. The touchscreen may unfortunately recognize a point different from a point intended by the operator, which results in transmission of an input signal including content different from what the operator intends.

In view of the foregoing background, it is an object of the present invention to provide a chromatograph input device, capable of transmitting a correct input signal corresponding to a touch gesture of an operator to a touchscreen, and a chromatograph.

### Solution to the Problem

(1) An aspect of the present invention is directed to a chromatograph input device that includes a display, a display processing unit, a storage, and a selection processing unit. The display has a touchscreen display monitor. The display processing unit has a chromatogram displayed on the display monitor. The storage stores at least one of data pieces of a peak start point, a peak end point, a peak top, and a boundary point and a boundary line between consecutive peaks on the chromatogram, as peak information. The selection processing unit selects any of the at least one peak information piece or any peak included in the chromatogram displayed on the display monitor, based on the location of a touch gesture to the chromatogram.

With this configuration, in response to a touch gesture of an operator to the touchscreen display monitor displaying a chromatogram, peak information or a peak of the chromatogram is automatically selected based on the location of the touch. The selected peak information is any of a peak start point, a peak end point, a peak top, and a boundary point and a boundary line between consecutive peaks on the chromatogram.

For example, when an operator makes a touch gesture to the touchscreen display monitor, and accidentally touches a region centering around a point slightly remote from a peak start point on the chromatogram, the start point of the peak is selected by the selection processing unit. Likewise, when an operator makes a touch gesture to select another peak information piece or a peak, and accidentally touches a region centering around a point slightly remote from a point to be touched, the intended information piece is selected by the selection processing unit.

This configuration contributes to preventing information different from information intended by the operator from being accidentally recognized when the operator makes a touch gesture to a touchscreen display monitor displaying the chromatogram. A correct input signal corresponding to the touch gesture to the touchscreen can thus be transmitted.

(2) The chromatograph input device may further include an arithmetic processing unit. When the selection processing unit selects any peak on the chromatogram, the arithmetic processing unit computes the height or the area of the peak.

In this configuration, the selection processing unit properly selects a peak, and the arithmetic processing unit computes the height or the area of the peak. This configuration allows proper computation of the height or the area of a peak even through a touch gesture of an operator to the touchscreen.

(3) The chromatograph input device may further include a baseline creation processing unit. When the selection processing unit selects a peak information of a peak start point, a peak end point, or a boundary point between consecutive peaks, the baseline creation processing unit creates data of a baseline in response to a touch gesture to the chromatogram displayed on the display monitor.

In this configuration, the selection processing unit properly selects a peak start point, a peak end point, or a boundary point between consecutive peaks, and in response to a subsequent touch gesture, data of a baseline is created. This configuration allows the baseline creation processing unit to create a proper baseline, even through a touch gesture of an operator to the touchscreen.

(4) The chromatograph input device may further include an arithmetic processing unit. The arithmetic processing unit computes the height or the area of a peak based on data of the baseline created by the baseline creation processing unit.

In this configuration, the baseline creation processing unit creates a proper baseline, and the arithmetic processing unit computes the height or the area of a peak based on the data of the baseline. This configuration allows proper computation of the height or the area of a peak even through a touch gesture of an operator to the touchscreen.

(5) The chromatograph input device may further include a peak separation processing unit. When the selection processing unit selects peak information of a boundary point or a boundary line between consecutive peaks, the peak separation processing unit separates the consecutive peaks from each other by the boundary point or the boundary line, in response to a touch gesture to the chromatogram displayed on the display monitor.

In this configuration, the selection processing unit properly selects a boundary point or a boundary line between consecutive peaks, and in response to a subsequent touch gesture, the consecutive peaks are separated from each other by the boundary point or the boundary line. This configuration allows the peak separation processing unit to properly separate peaks from each other, even through a touch gesture of an operator to the touchscreen.

(6) The chromatograph input device may further include an arithmetic processing unit. The arithmetic processing unit computes the height or the area of a peak separated by the peak separation processing unit.

In this configuration, the peak separation processing unit properly separates peaks from each other, and the arithmetic processing unit computes the height or the area of the separated peak. This configuration allows proper computation of the height or the area of a peak, even through a touch gesture of an operator to the touchscreen.

(7) The chromatograph input device may further include a peak integration processing unit. When the selection processing unit selects peak information of a boundary point or a boundary line between consecutive peaks, the peak integration processing unit integrates the consecutive peaks separated by the boundary point or the boundary line, in response to a touch gesture to the chromatogram displayed on the display monitor.

In this configuration, the selection processing unit properly selects a boundary point or a boundary line between consecutive peaks, and the consecutive peaks separated by the boundary point or the boundary line are integrated in response to a subsequent touch gesture. This configuration allows the peak integration processing unit to properly integrate peaks, even through a touch gesture of an operator to the touchscreen.

(8) The chromatograph input device may further include an arithmetic processing unit. The arithmetic processing unit computes the height or the area of a peak integrated by the peak integration processing unit. In this configuration, the peak integration processing unit properly integrates peaks, and the arithmetic processing unit computes the height or the area of the integrated peak. This configuration allows proper computation of the height or the area of a peak, even through a touch gesture of an operator to the touchscreen.

(9) The chromatograph input device may further include a peak information rewriting processing unit. When the selection processing unit selects a peak information of a peak start point, a peak end point, a peak top, or a boundary point or a boundary line between consecutive peaks, the peak information rewriting processing unit rewrites the peak information stored in the storage in response to a touch gesture to the chromatogram displayed on the display monitor.

This configuration allows peak information stored in the storage to be easily rewritten into desired information with a touch gesture to the touchscreen.

(10) The chromatograph input device may further include an arithmetic processing unit. The arithmetic processing unit computes the height or the area of a peak based on the peak information rewritten by the peak information rewriting processing unit.

In this configuration, the peak information rewriting processing unit rewrites peak information into desired information, and the arithmetic processing unit computes the height or the area of a peak based on the rewritten desired peak information. This configuration allows proper computation of the height or the area of a peak even through a touch gesture of an operator to the touchscreen.

(11) The chromatograph input device may further include a peak information deletion processing unit. When the selection processing unit selects any peak included in the chromatogram, the peak information deletion processing unit deletes peak information, stored in the storage, of the peak in response to a touch gesture to the chromatogram displayed on the display monitor.

In this configuration, the selection processing unit properly selects any peak included in the chromatogram, and peak information of the peak is deleted in response to a subsequent touch gesture. This configuration allows the peak information deletion processing unit to properly delete peak information even through a touch gesture of an operator to the touchscreen.

(12) The chromatograph of the present invention includes a chromatograph input device and a body. More specifically, the body includes the chromatograph input device.

With this configuration, an operator makes a touch gesture to a touchscreen display monitor of the chromatograph input device included in the body, and the selection processing unit automatically selects peak information or a peak of a chromatogram. This configuration allows peak information or a peak of the chromatogram to be selected by simply operating the body.

### Advantages of the Invention

In an aspect of the present invention, the selection processing unit automatically selects peak information or a peak of a chromatogram based on the location of a touch on a touchscreen display monitor displaying the chromatogram. This configuration contributes to preventing information different from information intended by an operator from being accidentally recognized, which allows transmission of a correct input signal corresponding to the touch gesture to the touchscreen.

### BRIEF DESCRIPTION OF THE DRAWINGS

FIG. 1 is a schematic diagram of an exemplary configuration of a gas chromatograph according to an embodiment of the present invention.

FIG. 2 is a block diagram of detailed configurations of a controller, and its peripheral devices, of the gas chromatograph of FIG. 1.

FIG. 3 is a schematic diagram illustrating an exemplary display mode of a display monitor.

FIG. 4 is a schematic diagram illustrating an exemplary display mode of the chromatogram region and illustrating a chromatogram and peak information.

FIG. 5 is a schematic diagram illustrating an exemplary display mode of the chromatogram region and illustrating computation of the height and the area of a peak of the chromatogram subsequent to selection of the peak.

FIG. 6A is a schematic diagram illustrating an exemplary display mode of the chromatogram region and illustrating selection of a peak start point and a peak end point on the chromatogram.

FIG. 6B is a schematic diagram illustrating an exemplary display mode of the chromatogram region and illustrating creation of a baseline.

FIG. 6C is a schematic diagram illustrating an exemplary display mode of the chromatogram region and illustrating computation of the height and the area of a peak of the chromatogram based on the baseline.

FIG. 6D is a schematic diagram illustrating an exemplary display mode of the chromatogram region and illustrating separation of peaks.

FIG. 6E is a schematic diagram illustrating an exemplary display mode of the chromatogram region and illustrating computation of the height and the area of each separated peak.

FIG. 7A is a schematic diagram illustrating an exemplary display mode of the chromatogram region and illustrating rewriting of peak information on the chromatogram.

FIG. 7B is a schematic diagram illustrating an exemplary display mode of the chromatogram region and illustrating computation of the height and the area of a peak of the chromatogram based on the rewritten peak information.

FIG. 8 is a schematic diagram illustrating an exemplary display mode of the chromatogram region and illustrating deletion of peak information on the chromatogram.

### DESCRIPTION OF EMBODIMENTS

1. Overall Configuration of Gas Chromatograph

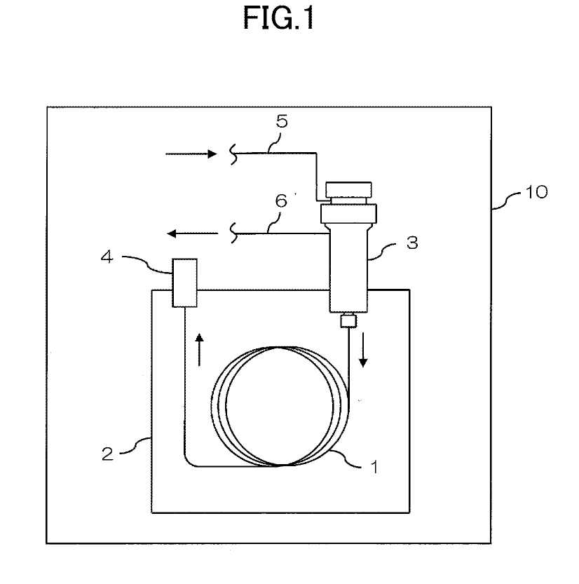

FIG. 1 is a schematic diagram of an exemplary configuration of a gas chromatograph according to an embodiment of the present invention. The gas chromatograph performs an analysis by feeding sample gas into a column 1 along with carrier gas. The gas chromatograph includes, other than the column 1, a column oven 2, a sample introduction unit 3, a detector 4, and a hollow body 10 accommodating these units. Examples of the column 1 include a capillary column The column 1 is accommodated in the column oven 2 along with a heater, a fan, and others (none illustrated). The column oven 2 is used for heating the column 1 and drives the heater and the fan as appropriate in analysis.

The sample introduction unit 3 is used for introducing carrier gas and sample gas into the column 1 and accommodates therein a sample vaporization chamber (not illustrated). A liquid sample is injected to the sample vaporization chamber, vaporized therein, and the vaporized sample is introduced to the column 1 along with carrier gas. The sample vaporization chamber communicates with a gas supply line 5 and a split flow line 6. The gas supply line 5 is a flow path through which carrier gas is fed into the sample vaporization chamber of the sample introduction unit 3.

The split flow line 6 is a flow path through which a part of gas (a gas mixture containing carrier gas and sample gas) in the sample vaporization chamber is discharged outside at a predetermined split ratio when the carrier gas and the sample gas are introduced to the column 1 by split injection.

Examples of the detector 4 include a flame ionization detector (FID) and a flame photometric detector (FPD). The detector 4 sequentially detects sample components contained in the carrier gas introduced through the column 1.

In sample analysis using this type of gas chromatograph, a sample to be analyzed is injected to the sample introduction unit 3. The sample is vaporized in the sample vaporization chamber. The sample vaporization chamber of the sample introduction unit 3 further receives carrier gas through the gas supply line 5.

The sample vaporized in the sample vaporization chamber is introduced into the column 1 along with the carrier gas. Sample components contained in the sample are separated from one another while passing through the column 1 and sequentially introduced to the detector 4.

The detector 4 sequentially detects each sample component contained in the carrier gas introduced from the column 1. Based on results of detection by the detector 4, a chromatogram is created. The created chromatogram is displayed on the display 11 (described later) included in the body 10. An operator checks the displayed chromatogram and conducts various analyses.

2. Detailed Configuration of Controller and Peripheral Devices

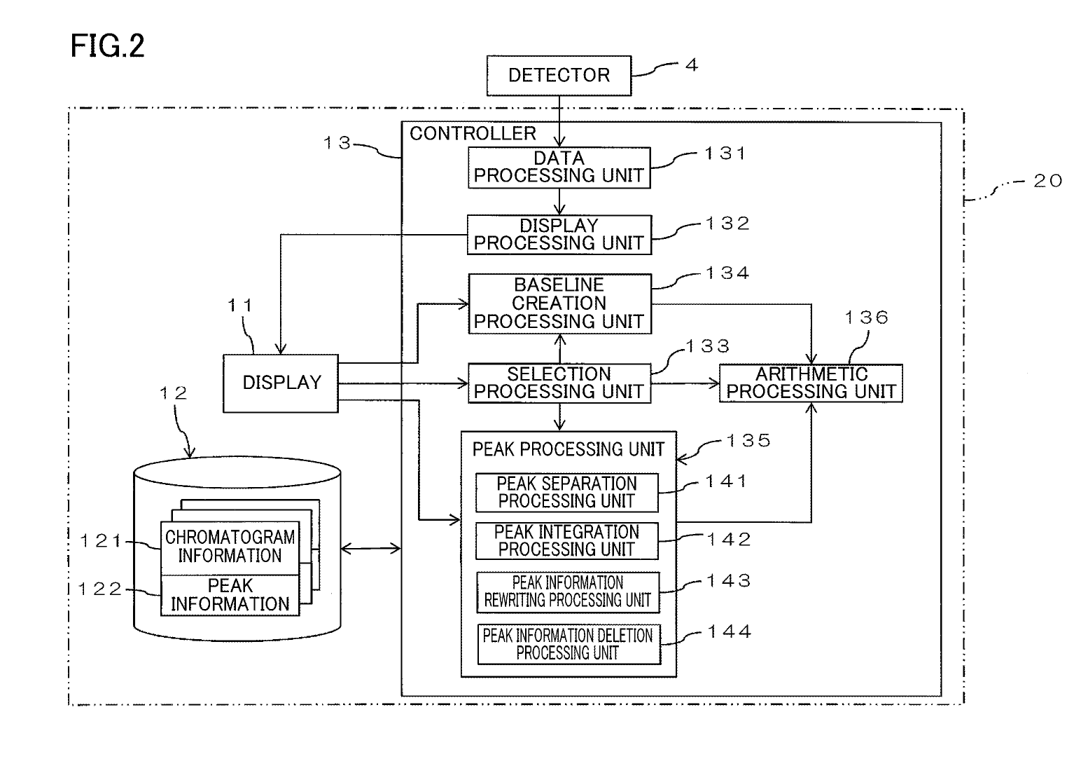

FIG. 2 is a block diagram of detailed configurations of a controller 13, and its peripheral devices, of the gas chromatograph of FIG. 1.

The gas chromatograph includes, other than the above detector 4, the display 11, a storage 12, and a controller 13. In the gas chromatograph, the display 11, the storage 12, and the controller 13 serve as an input device 20. The input device 20 is included in the body 10 (see FIG. 1).

The display 11 includes a capacitive touchscreen. In analysis using this type of gas chromatograph, an operator checks information on the display 11 and makes an input with the display 11.

The storage 12 includes a read only memory (ROM), a random access memory (RAM), and other devices. The storage 12 stores a plurality of pieces of chromatogram information 121 and peak information 122. The chromatogram information 121 is information of a chromatogram created by the later-described data processing unit 131 based on a detection signal from the detector 4. The peak information 122 is information relating to a peak in the chromatogram information 121.

The controller 13 includes, for example, a central processing unit (CPU). The controller 13 is capable of controlling transmission of an electric signal between the detector 4 and the display 11. The controller 13 further controls input and output of data to/from the storage 12 as necessary. With the CPU executing a program, the controller 13 functions, for example, as a data processing unit 131, a display processing unit 132, a selection processing unit 133, a baseline creation processing unit 134, a peak processing unit 135, and an arithmetic processing unit 136.

The data processing unit 131 obtains a chromatogram and detects information relating to a peak included in the chromatogram, based on a detection signal from the detector 4. Information of the chromatogram created by the data processing unit 131 is stored in the storage 12 as the chromatogram information 121. Information relating to a peak detected by the data processing unit 131 is stored in the storage 12 as the peak information 122. The chromatogram information 121 and the peak information 122 are stored in the storage 12 in association with each other.

The display processing unit 132 has a chromatogram displayed on the display 11 based on the chromatogram information 121 in the storage 12. The display processing unit 132 also has information relating to a peak displayed on the display 11 based on results of processing by the later-described selection processing unit 133, baseline creation processing unit 134, peak processing unit 135, and arithmetic processing unit 136.

The selection processing unit 133 selects and read certain information from the peak information 122 in the storage 12, based on an input signal that has been input using the touchscreen and transmitted from the display 11.

The baseline creation processing unit 134 creates a baseline to be displayed on the display 11 along with the chromatogram, based on an input signal that has been input using the touchscreen and transmitted from the display 11.

The peak processing unit 135 provides various kinds of processing on a peak of the chromatogram, based on an input signal that has been input using the touchscreen and transmitted from the display 11. More specifically, the peak processing unit 135 includes a peak separation processing unit 141, a peak integration processing unit 142, a peak information rewriting processing unit 143, and a peak information deletion processing unit 144. These units perform various kinds of processing. The peak separation processing unit 141 separates peaks of the chromatogram displayed on the display 11 from one another, based on an input signal that has been input using the touchscreen and transmitted from the display 11.

The peak integration processing unit 142 integrates separated peaks of the chromatogram displayed on the display 11, based on an input signal that has been input using the touchscreen and transmitted from the display 11.

The peak information rewriting processing unit 143 rewrites the peak information 122 stored in the storage 12, based on an input signal that has been input using the touchscreen and transmitted from the display 11. The peak information deletion processing unit 144 deletes the peak information 122 stored in the storage 12, based on an input signal that has been input using the touchscreen and transmitted from the display 11.

The arithmetic processing unit 136 computes the height and the area of a peak of the chromatogram based on results of processing by the selection processing unit 133, the baseline creation processing unit 134, the peak separation processing unit 141, the peak integration processing unit 142, the peak information rewriting processing unit 143, and the peak information deletion processing unit 144.

3. Display Form on Display Monitor

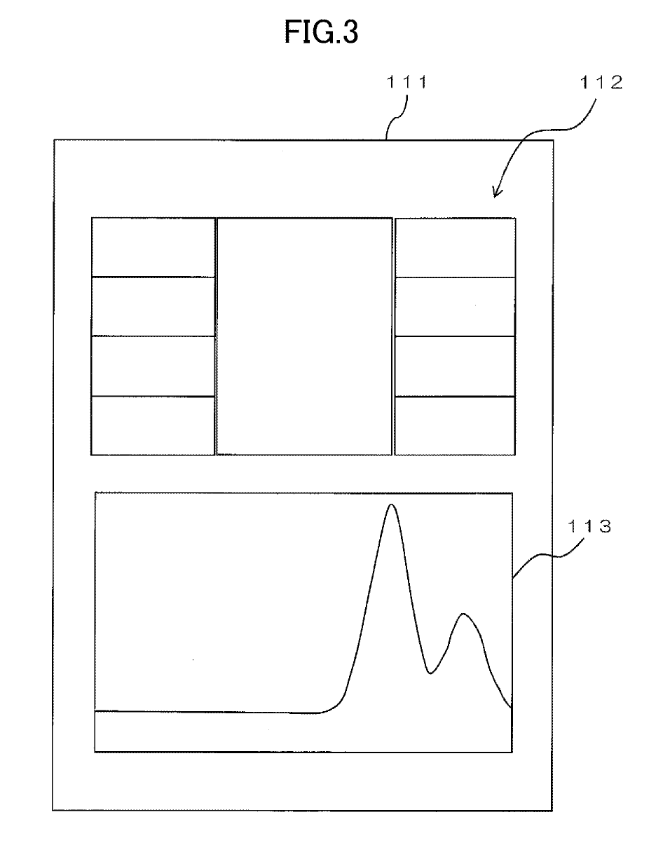

FIG. 3 is a schematic diagram illustrating an exemplary display mode of the display monitor 111. The above display 11 includes the touchscreen display monitor 111. The display 11 is included in the body 10 (see FIG. 1) and allows an operator to see the display monitor 111 on the body 10. More specifically, the display 11 is provided to a front surface of the body 10 for easy operation by an operator. The body 10 usually has an openable and closable door or the like on its front surface. The display 11 is therefore disposed in a comparatively compact space on the front surface of the body 10 to secure spaces for the door or the like.

The display monitor 111 is substantially rectangular. The display monitor 111 includes an operation display region 112 and a chromatogram region 113. The operation display region 112 is arranged in the upper part of the display monitor 111. The operation display region 112 is a region for displaying conditions of operation of various units of the gas chromatograph. For example, the operation display region 112 displays the temperature of the column 1, the temperature and the pressure inside the sample introduction unit 3, the flow rate of carrier gas to be fed into the sample introduction unit 3, the temperature of the detector 4, and other conditions relating to operation.

The chromatogram region 113 is arranged in the lower part of the display monitor 111. The chromatogram region 113 is a region for displaying a chromatogram created by the data processing unit 131. The chromatogram region 113 displays a chromatogram in a two-dimensional x-y graph having time on the x-axis and signal intensity on the y-axis.

During analysis by the gas chromatograph, the display monitor 111 of the display 11 displays a chromatogram in real time. During analysis, when the data processing unit 131 creates a chromatogram based on a detection signal from the detector 4, the display processing unit 132 has the chromatogram displayed in the chromatogram region 113 of the display monitor 111 in real time.

4. Detection of Peak Information

As described above, when the data processing unit 131 creates a chromatogram, information of the chromatogram is stored in the storage 12 as the chromatogram information 121 (see FIG. 2). The data processing unit 131 detects information relating to a peak of the chromatogram and stores the information in the storage 12 as the peak information 122.

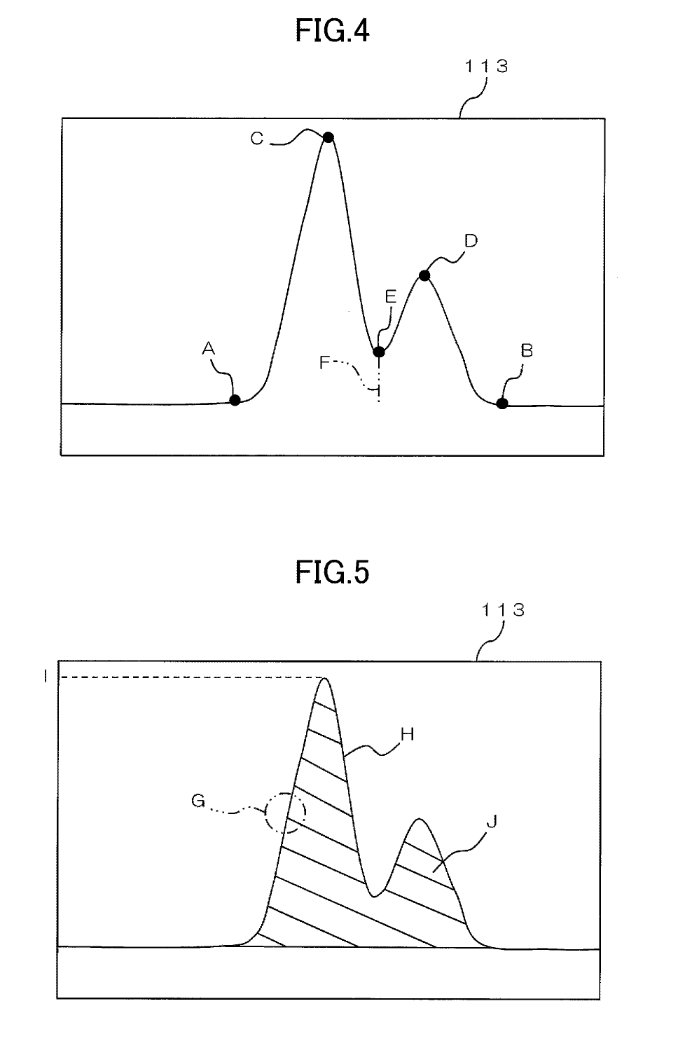

FIG. 4 is a schematic diagram illustrating an exemplary display mode of the chromatogram region 113 and illustrating a chromatogram and peak information. In FIG. 4, a chromatogram corresponding to certain chromatogram information 121 stored in the storage 12 is partially displayed.

Specifically, information stored in the storage 12 as the peak information 122 includes a peak start point, a peak end point, a peak top, and a boundary point and a boundary line between consecutive peaks, of the chromatogram information 121. The peak start point, the peak end point, the peak top, and the boundary point between consecutive peaks are points (singular points) at which signal intensity drastically changes. The data processing unit 131 detects the peak information 122 based on a change in signal intensity on the chromatogram.

With regard to the chromatogram illustrated in FIG. 4, the storage 12 stores, as the peak information 122, information of a peak start point A, a peak end point B, peak tops C and D, and a boundary point E and a boundary line F between consecutive peaks. These peak information pieces 122 are selected based on the location of a touch to the display 11 by an operator, which will be described later. The boundary line F is a straight line parallel to the vertical axis and passing through the boundary point E. The boundary point E and the boundary line F are occasionally not included in the peak information 122 depending on the shape of a peak.

5. Control Operation of Controller and Display Mode of Display Monitor

In the gas chromatograph, the chromatogram information 121 stored in the storage 12 is read, and a chromatogram corresponding to the read information is displayed in the chromatogram region 113, in response to a predetermined touch gesture of an operator to the display 11. In this condition, the operator can check the height and the area of a peak of the chromatogram or change the peak information 122 by making a corresponding touch gesture to the display 11.

The following is description about a touch gesture of an operator, a control operation of the controller 13, and a display mode of the display monitor 111 (the chromatogram region 113), to check the height and the area of a chromatogram or to change the peak information 122.

(1) Selection of Peak

FIG. 5 is a schematic diagram illustrating an exemplary display mode of the chromatogram region 113 and illustrating computation of the height and the area of a peak of the chromatogram subsequent to selection of the peak.

In response to a predetermined touch gesture of an operator with a chromatogram displayed in the chromatogram region 113, the selection processing unit 133 selects a peak of the chromatogram.

For example, the chromatogram region 113 is displaying a chromatogram as illustrated in FIG. 4, and, in response to a touch (tap) to a region G by the operator as illustrated in FIG. 5, the selection processing unit 133 selects a peak H of the chromatogram. In FIG. 5, the region G is located between the start point and the top of the peak H of the chromatogram. In other words, in response to a touch to a region remote from singular points by a certain distance or larger, on the chromatogram or on a place slightly away from the chromatogram, the peak H corresponding to the touched region is selected.

The arithmetic processing unit 136 computes a height I and an area J of the peak H. Specifically, the maximum along the vertical axis with a baseline as a reference line is computed as the height I of the peak H, and the area of a region surrounded by the baseline and the peak H is computed as the area J of the peak H. Although not illustrated, the display processing unit 132 may have numerical values of the computed height I and the area J of the peak H displayed in the chromatogram region 113.

(2) Selection of Peak Information

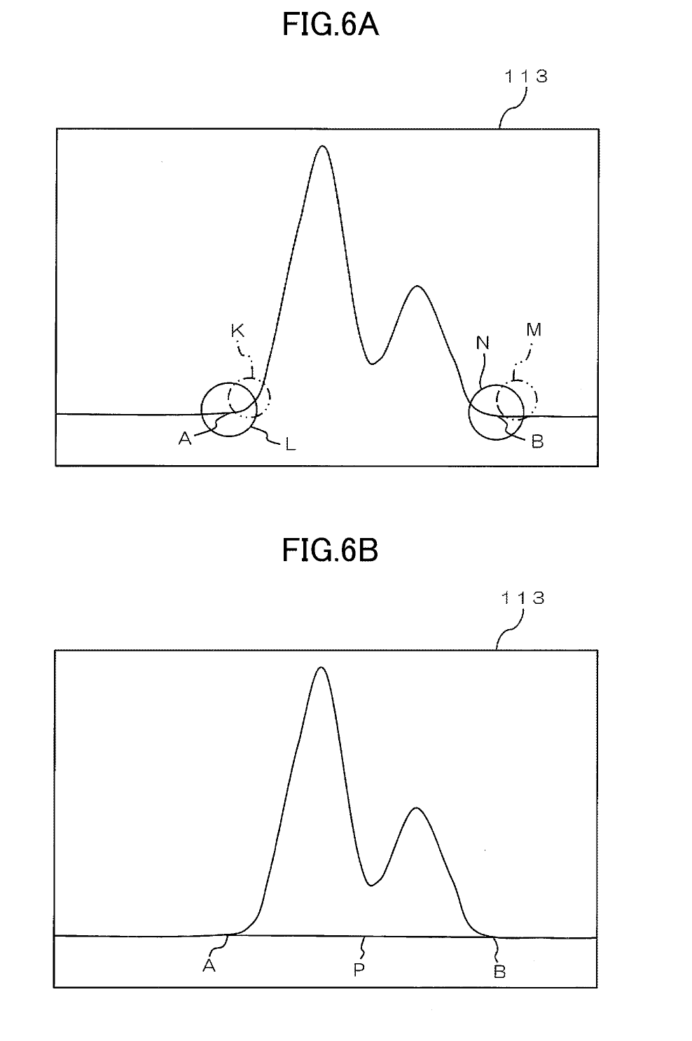

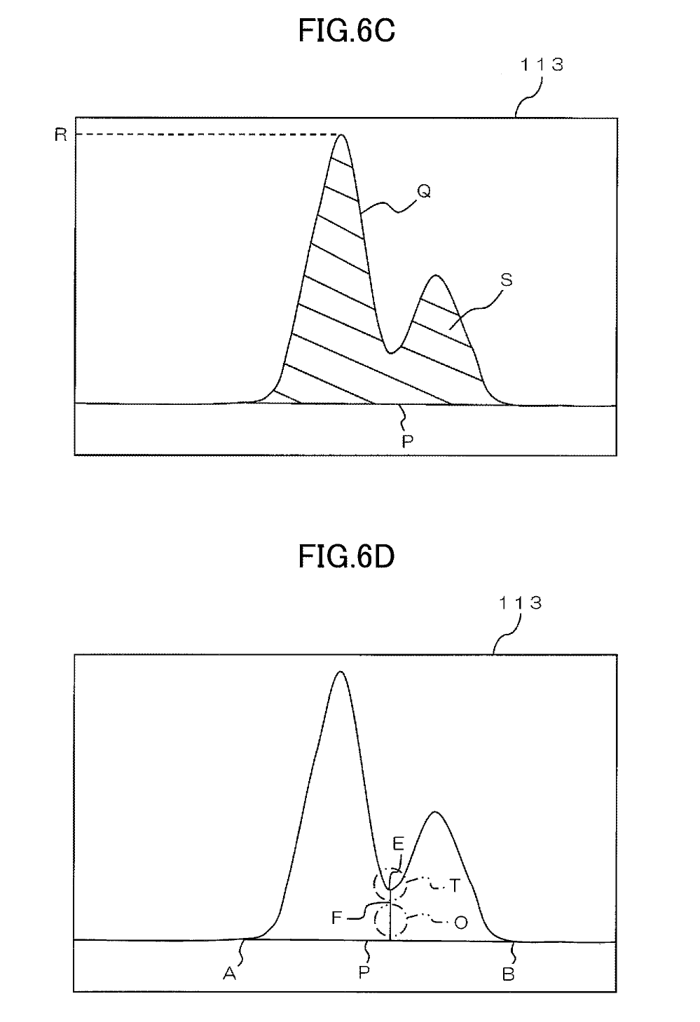

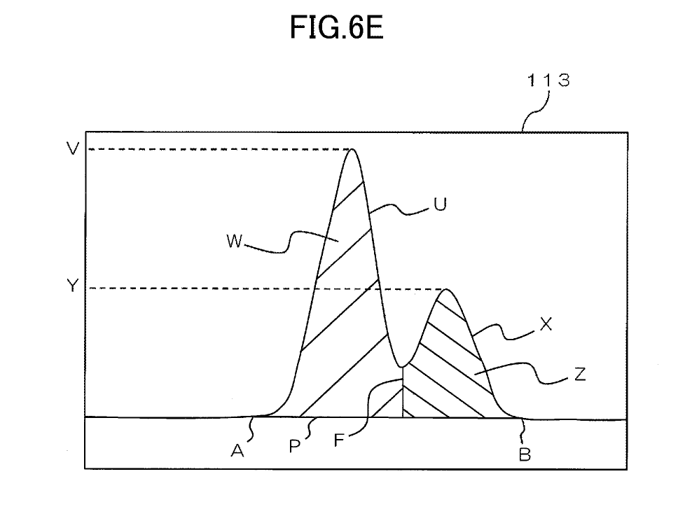

FIG. 6A is a schematic diagram illustrating an exemplary display mode of the chromatogram region 113 and illustrating selection of a peak start point and a peak end point of the chromatogram. FIG. 6B is a schematic diagram illustrating an exemplary display mode of the chromatogram region 113 and illustrating creation of a baseline P. FIG. 6C is a schematic diagram illustrating an exemplary display mode of the chromatogram region 113 and illustrating computation of the height and the area of a peak of the chromatogram based on the baseline P.

In response to a predetermined touch gesture by an operator with a chromatogram displayed in the chromatogram region 113, the selection processing unit 133 selects information corresponding to the location of the touch from the peak information 122 stored in the storage 12.

For example, the chromatogram region 113 is displaying a chromatogram as illustrated in FIG. 4, and, in response to a touch (tap) to a region K by the operator as illustrated in FIG. 6A, the selection processing unit 133 selects the peak start point A (see FIG. 4) on the chromatogram from the peak information 122 stored in the storage 12. The display processing unit 132 has a figure L, such as a circle, indicating the location of the start point A displayed in the chromatogram region 113. The region K is a region located on the peak start point A or a region remote from the peak start point A by less than a certain distance, on the chromatogram.

In response to a touch (tap) to a region M by the operator, the selection processing unit 133 selects the peak end point B (see FIG. 4) of the chromatogram from the peak information 122 stored in the storage 12. The display processing unit 132 has a figure N, such as a circle, indicating the location of the peak end point B displayed in the chromatogram region 113. The region M is a region located on the peak end point B or a region remote from the peak end point B by less than a certain distance, on the chromatogram.

When the operator makes a gesture (pinching out) to enlarge a certain part of the chromatogram region 113, the display processing unit 132 may have the part displayed in an enlarged manner When the operator makes a touch gesture to the enlarged part, the selection processing unit 133 may appropriately select information (a singular point) corresponding to the location of the touch in the enlarged part from the peak information 122.

Although not illustrated, the display processing unit 132 may have information (values) of time at the start point A and the end point B selected by the selection processing unit 133, displayed in the chromatogram region 113.

In this manner, the selection processing unit 133 selects information (a singular point) closest to the location of a touch of the operator, from the peak information 122 in the storage 12. If the operator accidentally touches the region K, which is an area slightly remote from the start point A, with the intention to select the start point A, the selection processing unit 133 selects the start point A as a singular point closest to the region K. Likewise, if the operator touches the region M, which is an area slightly remote from the end point B, with the intention to select the end point B, the selection processing unit 133 selects the end point B as a singular point closest to the region M. This manner of selection of a singular point is further employed to select singular points other than the start point A and the end point B, such as a peak top and a boundary point between consecutive peaks.

(3) Creation of Baseline

In response to touch gestures to select the start point A and the end point B, as described above, in a mode for creating a baseline, the baseline creation processing unit 134 creates the baseline P connecting between the selected start point A and end point B as illustrated in FIG. 6B. At this moment, the display processing unit 132 has the created baseline P displayed in the chromatogram region 113.

The arithmetic processing unit 136 computes the height and the area of a peak based on the baseline P as illustrated in FIG. 6C. Specifically, the arithmetic processing unit 136 computes the height R and the area S of a peak Q located above the baseline P. Although not illustrated, the display processing unit 132 may have numerical values of the computed height R and area S of the peak Q displayed in the chromatogram region 113. Touch gestures different from the above touch gesture may be employed to select a peak start point and a peak end point and to create the baseline P.

For example, when an operator touches (taps) the region K (see FIG. 6A) and subsequently makes a slide (drag) gesture toward the right to the region M, the selection processing unit 133 may select the peak start point A and the peak end point B, and the baseline creation processing unit 134 may create the baseline P (see FIG. 6B) connecting between the start point A and the end point B.

Although not illustrated, when an operator taps a location near the start point A (see FIG. 4) and subsequently taps a location near the boundary point E of the peak, the baseline creation processing unit 134 may create a baseline connecting between the start point A and the boundary point E.

(4) Separation and Integration of Peak

FIG. 6D is a schematic diagram illustrating an exemplary display mode of the chromatogram region 113 and illustrating separation of peaks. FIG. 6E is a schematic diagram illustrating an exemplary display mode of the chromatogram region 113 and illustrating computation of the height and the area of each separated peak.

For example, in the condition illustrated in FIG. 6B, an operator presses and holds (long touch) a region T centering around a boundary point E between consecutive peaks as illustrated in FIG. 6D. When the operator subsequently makes a downward slide (drag) gesture while holding the region T, the selection processing unit 133 selects a boundary line F between consecutive peaks among the peak information pieces 122 stored in the storage 12. The peak separation processing unit 141 separates the consecutive peaks of the chromatogram by the boundary line F. The display processing unit 132 has the boundary line F displayed in the chromatogram region 113.

Even when the operator accidentally presses and holds a portion slightly remote from the region T by less than a certain distance and makes a downward slide gesture, the peak separation processing unit 141 separates the peaks of the chromatogram.

The arithmetic processing unit 136 computes the height and the area of each peak separated by the boundary line F as illustrated in FIG. 6E. Specifically, the arithmetic processing unit 136 computes the height V and the area W of a peak U located above the baseline P and further computes the height Y and the area Z of a peak X located above the baseline P and next to the peak U. Although not illustrated, the display processing unit 132 may have numerical values of the computed height V and area W of the peak U and the computed height Y and area Z of the peak X, displayed in the chromatogram region 113.

In the condition in which the peaks are separated, when the operator presses and holds (long touch) a region O centering around the boundary line F as illustrated in FIG. 6D and makes a downward slide (drag) gesture while holding the region O, the peak integration processing unit 142 integrates the separated peaks. The display processing unit 132 deletes the boundary line F from the chromatogram region 113 as illustrated in FIG. 6B.

Even when the operator accidentally presses and holds a portion slightly remote from the region O by less than a certain distance and makes a downward slide gesture, the peak integration processing unit 142 integrates the peaks of the chromatogram. As described above, the arithmetic processing unit 136 computes the height and the area of the integrated peak. Another type of touch gesture different from the above touch gesture may be employed for separation and integration of peaks.

For example, in response to a touch (tap) to the region T illustrated in FIG. 6D by the operator, the selection processing unit 133 may select the boundary point E between the peaks. Furthermore, in response to a tap of a portion on the baseline P located below the region T, the peak separation processing unit 141 may separate the peaks.

In the condition in which the peaks of the chromatogram are separated by the boundary line F, when the operator touches (taps) the region O illustrated in FIG. 6D and subsequently taps a portion on the baseline P located below the region O, the peak integration processing unit 142 may integrate the peaks of the chromatogram.

The peak integration processing unit 142 may integrate peaks separated in an initial state, in addition to peaks separated by the peak separation processing unit 141.

(5) Rewriting of Peak Information

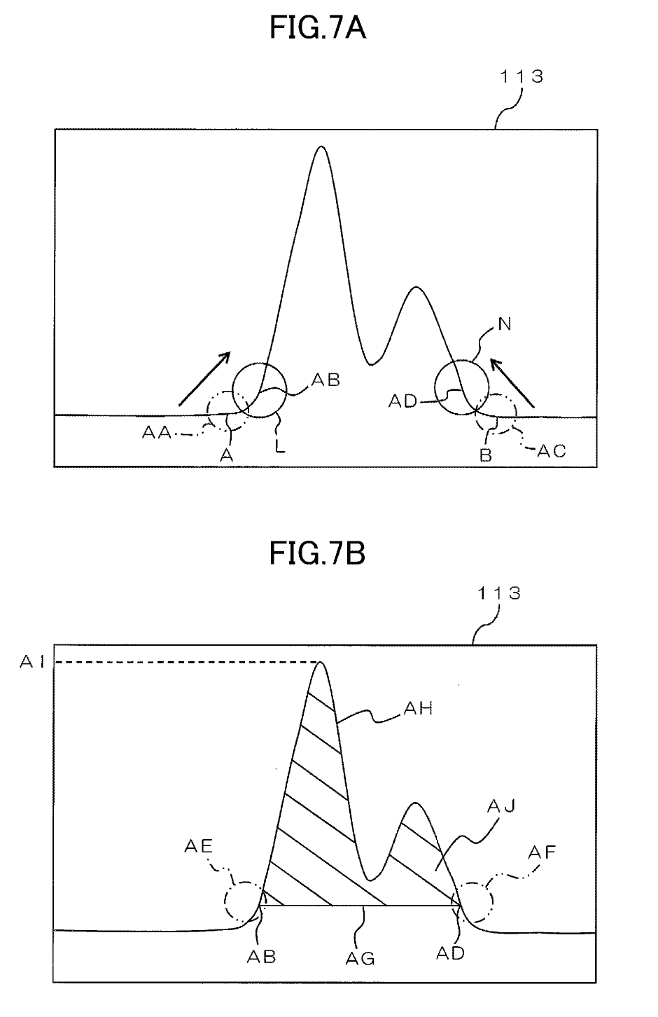

FIG. 7A is a schematic diagram illustrating an exemplary display mode of the chromatogram region 113 and illustrating rewriting of peak information on the chromatogram. FIG. 7B is a schematic diagram illustrating an exemplary display mode of the chromatogram region 113 and illustrating computation of the height and the area of a peak of the chromatogram based on the rewritten peak information.

In the condition illustrated in FIG. 6A, when an operator presses and holds (long touch) a region AA centering around the peak start point A and subsequently makes a slide (drag) gesture along the chromatogram while holding the region AA as illustrated in FIG. 7A, the display processing unit 132 moves the figure L (see FIG. 6A) along the slide gesture of the operator.

When the operator lets the finger off the chromatogram region 113, the peak information rewriting processing unit 143 regards a point indicated by the figure L after move as a new start point AB and rewrites information of the start point A in the peak information 122 stored in the storage 12 into information of the start point AB.

When the operator presses and holds (long touch) a region AC centering around the peak end point B and subsequently makes a slide (drag) gesture along the chromatogram while holding the region AC, the display processing unit 132 moves the figure N (see FIG. 6A) along the slide gesture of the operator.

When the operator lets the finger off the chromatogram region 113, the peak information rewriting processing unit 143 regards a point indicated by the figure N after move as a new end point AD and rewrites information of the end point B in the peak information 122 stored in the storage 12 into information of the end point AD.

In response to a touch gesture of the operator to the chromatogram in the chromatogram region 113, the selection processing unit 133 selects information from the new peak information 122 in the storage 12.

Even when the operator accidentally taps a region AE slightly remote from the start point AB, as illustrated in FIG. 7B, the selection processing unit 133 selects the new rewritten start point AB from the peak information 122 in the storage 12. Likewise, even when the operator taps a region AF slightly remote from the end point AD, the selection processing unit 133 selects the new rewritten end point AD from the peak information 122 in the storage 12. In response to touch gestures to select the above start point AB and end point AD in a mode for creating a baseline, the baseline creation processing unit 134 creates a baseline AG connecting between the selected start point AB and end point AD. At this moment, the display processing unit 132 has the created baseline AG displayed in the chromatogram region 113.

The arithmetic processing unit 136 computes a height AI and an area AJ of a peak AH located above the baseline AG. Although not illustrated, the display processing unit 132 may have numerical values of the computed height AI and area AJ of the peak AH displayed in the chromatogram region 113.

Although not illustrated, when the operator presses and holds (long touch) a peak top, a boundary point between peaks, or a boundary line between peaks and makes a slide (drag) gesture while holding the portion, the peak information rewriting processing unit 143 rewrites these information pieces in the peak information 122 stored in the storage 12, as described above.

(6) Deletion of Peak Information

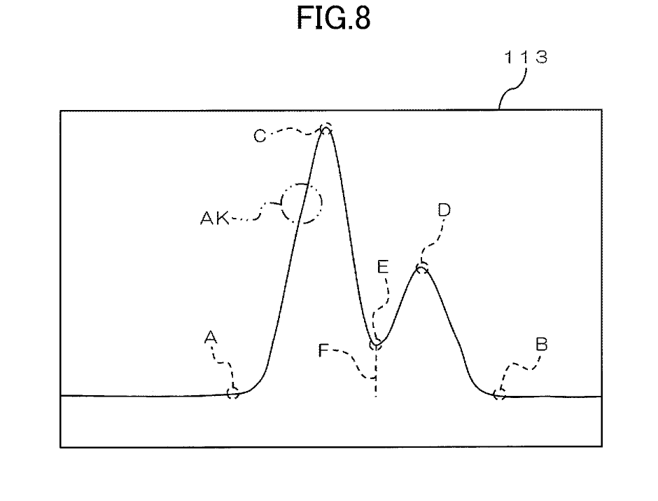

FIG. 8 is a schematic diagram illustrating an exemplary display mode of the chromatogram region 113 and illustrating deletion of peak information on the chromatogram.

When, as illustrated in FIG. 5, the operator selects a peak and presses and holds (long touch) a linear portion (a portion other than a singular point) of the peak over a certain time period, the peak information deletion processing unit 144 deletes the peak information 122 relating to the peak from the storage 12. For example, as illustrated in FIG. 8, when the operator presses and holds (long touch) a region AK located between the peak start point and the peak top over a certain time period, the peak information deletion processing unit 144 deletes the peak information 122 relating to the peak stored in the storage 12.

More specifically, when the operator presses and holds (long touch) the region AK over a certain time period, the display processing unit 132 has a window (a pop-up window) displayed in the chromatogram region 113, although not illustrated, to ask whether to delete the peak information 122 from the storage 12. When the operator makes a predetermined touch gesture on the display monitor to delete the peak information 122, the peak information deletion processing unit 144 deletes the peak information 122 stored in the storage 12.

6. Advantageous Effects

(1) In this embodiment, as illustrated in FIG. 2, the storage 12 stores information of a peak start point, a peak end point, a peak top, and a boundary point and a boundary line between consecutive peaks on a chromatogram, as the peak information 122. The selection processing unit 133 selects the peak information 122 or any peak of the chromatogram displayed on the display monitor 111, based on the location of a touch gesture to the chromatogram.

In response to a touch gesture of an operator to the touchscreen display monitor 111 displaying a chromatogram, either the peak information 122 or a peak is automatically selected based on the location of the touch. The selected peak information 122 is a peak start point, a peak end point, a peak top, or a boundary point or a boundary line between consecutive peaks on the chromatogram.

For example, as illustrated in FIG. 6A, even when an operator makes a touch gesture to the touchscreen display monitor 111, and accidentally touches a region K centering around a point slightly remote from the start point A of a peak of the chromatogram, the start point A of the peak is selected by the selection processing unit 133. Likewise, when the operator makes a touch gesture to select another peak information piece or a peak, and accidentally touches a region centering around a point slightly remote from a point to be touched, the intended information piece is selected by the selection processing unit 133.

This configuration contributes to preventing information different from information intended by the operator from being accidentally recognized when the operator makes a touch gesture to the touchscreen display monitor 111 displaying the chromatogram. A correct input signal corresponding to the touch on the touchscreen can thus be transmitted. The storage 12 is not necessarily configured to store all information pieces including a peak start point, a peak end point, a peak top, and a boundary point and a boundary line between consecutive peaks on a chromatogram, and may be configured to store at least an information piece of the peak information pieces 122.

(2) In this embodiment, when the selection processing unit 133 selects any peak included in a chromatogram, the arithmetic processing unit 136 computes the height and the area of the peak as illustrated in FIG. 5.

In this configuration, the selection processing unit 133 properly selects a peak, and the arithmetic processing unit 136 computes the height and the area of the peak. This configuration allows proper computation of the height and the area of a peak, even through a touch gesture of an operator to the touchscreen. The device is not necessarily configured to compute both the height and the area of a peak and may compute either one of them.

(3) In this embodiment, when the selection processing unit 133 selects information of a peak start point, a peak end point, or a boundary point between consecutive peaks from the peak information 122, the baseline creation processing unit 134 creates data of a baseline as illustrated in FIG. 6B, in response to a touch gesture to a chromatogram displayed on the display monitor 111.

In this configuration, the selection processing unit 133 properly selects a peak start point, a peak end point, or a boundary point between consecutive peaks, and data of a baseline is created in response to a subsequent touch gesture. This configuration allows the baseline creation processing unit 134 to create a proper baseline, even through a touch gesture of an operator to the touchscreen.

(4) In this embodiment, the arithmetic processing unit 136 computes the height and the area of a peak as illustrated in FIG. 6C based on data of the baseline created by the baseline creation processing unit 134.

In this configuration, the baseline creation processing unit 134 creates a proper baseline, and based on data of the baseline, the arithmetic processing unit 136 computes the height and the area of the peak. This configuration allows proper computation of the height and the area of a peak, even through a touch gesture of an operator to a touchscreen. The device is not necessarily configured to compute both the height and the area of a peak and may compute either one of them.

(5) In this embodiment, when the selection processing unit 133 selects a boundary point between consecutive peaks from the peak information 122, the peak separation processing unit 141 separates the consecutive peaks by the boundary point as illustrated in FIG. 6D, in response to a touch gesture to the chromatogram displayed on the display monitor 111.

In this configuration, the selection processing unit 133 properly selects a boundary point between consecutive peaks, and in response to a subsequent touch gesture, the consecutive peaks are separated from each other by the boundary point. This configuration allows the peak separation processing unit 141 to properly separate peaks from each other, even through a touch gesture of an operator to the touchscreen. Consecutive peaks may be separated from each other in response to a touch gesture subsequent to selection of information of a boundary line, instead of a boundary point, between the consecutive peaks.

(6) In this embodiment, the arithmetic processing unit 136 computes the height and the area of each peak separated by the peak separation processing unit 141 as illustrated in FIG. 6E.

In this configuration, the peak separation processing unit 141 properly separates peaks from each other, and the arithmetic processing unit 136 computes the height and the area of the separated peak. This configuration allows proper computation of the height and the area of a peak, even through a touch gesture of an operator to the touchscreen. The device is not necessarily configured to compute both the height and the area of a peak and may compute either one of them.

(7) In this embodiment, when the selection processing unit 133 selects peak information of a boundary line between consecutive peaks, the peak integration processing unit 142 integrates the consecutive peaks separated by the boundary line, in response to a touch gesture to the chromatogram displayed on the display monitor 111.

In this configuration, the selection processing unit 133 properly selects a boundary line between consecutive peaks, and in response to a subsequent touch gesture, the consecutive peaks separated by the boundary line are integrated. This configuration allows the peak integration processing unit to properly integrate peaks, even through a touch gesture of an operator to the touchscreen. Consecutive peaks may be integrated in response to a touch gesture subsequent to selection of information of a boundary point, instead of a boundary line, between the consecutive peaks.

(8) In this embodiment, the arithmetic processing unit 136 computes the height and the area of a peak integrated by the peak integration processing unit 142.

In this configuration, the peak integration processing unit 142 properly integrates peaks, and the arithmetic processing unit 136 computes the height and the area of the integrated peak. This configuration allows proper computation of the height and the area of a peak, even through a touch gesture of an operator to the touchscreen. The device is not necessarily configured to compute both the height and the area of a peak and may compute either one of them.

(9) In this embodiment, when the selection processing unit 133 selects information of a peak start point, a peak end point, a peak top, or a boundary point or a boundary line between consecutive peaks from the peak information 122, as illustrated in FIG. 7A, the peak information rewriting processing unit 143 rewrites the peak information 122 stored in the storage 12, in response to a touch gesture to the chromatogram displayed on the display monitor 111.

This configuration facilitates rewriting of the peak information 122 stored in the storage 12 into desired information with a touch gesture to the touchscreen.

(10) In this embodiment, the arithmetic processing unit 136 computes the height and the area of a peak as illustrated in FIG. 7B based on the peak information rewritten by the peak information rewriting processing unit 143.

In this configuration, the peak information rewriting processing unit 143 rewrites the peak information 122 into desired information, and based on the rewritten desired peak information 122, the arithmetic processing unit 136 computes the height and the area of the peak. This configuration allows proper computation of the height and the area of a peak, even through a touch gesture of an operator to the touchscreen. The device is not necessarily configured to compute both the height and the area of a peak and may compute either one of them.

(11) In this embodiment, when the selection processing unit 133 selects any peak included in a chromatogram, the peak information deletion processing unit 144 deletes the peak information 122 relating to the peak stored in the storage 12, in response to a touch gesture to the chromatogram displayed on the display monitor 111.

In this configuration, the selection processing unit 133 properly selects any peak included in a chromatogram, and in response to a subsequent touch gesture, the peak information 122 relating to the peak is deleted. This configuration allows the peak information deletion processing unit 144 to properly delete peak information, even through a touch gesture of an operator to the touchscreen.

(12) In this embodiment, the input device 20 is included in the body 10. An operator makes a touch gesture to the touchscreen display monitor 111 included in the body 10. The selection processing unit 133 automatically selects the peak information 122 in the storage 12 or a peak of the chromatogram.

This configuration allows the peak information 122 in the storage 12 or a peak of a chromatogram to be selected by simply operating the body 10.

7. Modification

The chromatograph of the present invention has been described as a gas chromatograph; however, the chromatograph of the present invention is adaptable to chromatographs, other than a gas chromatograph, such as a liquid chromatograph.

Moreover, in the foregoing description, the selection processing unit 133 selects the peak information 122 or a peak in response to a specific touch gesture to a chromatogram in the chromatogram region 113; however, the peak information 122 may be selected in response to another touch gesture different from the specific touch gesture. A touch gesture subsequent to selection of the peak information 122 or a peak by the selection processing unit 133 is also not limited to the above specific touch gesture.

Furthermore, the input device 20 has been described as included in the body 10; however, the input device 20 only needs to have a touchscreen display monitor, and the input device 20 thus may be configured as a separate device from the body 10, such as a smart device and a personal computer display. In this case, the chromatogram information 121 and the peak information 122 are not necessarily obtained directly from an input signal from the detector 4, and may be stored in the storage 12 of the input device via wired or wireless communication.

### DESCRIPTION OF REFERENCE CHARACTERS

10 Body
11 Display
12 Storage
13 Controller
20 Input Device
111 Display Monitor
122 Peak Information
132 Display Processing Unit
133 Selection Processing Unit
134 Baseline Creation Processing Unit
135 Peak Processing Unit
136 Arithmetic Processing Unit
141 Peak Separation Processing Unit
142 Peak Integration Processing Unit
143 Peak Information Rewriting Processing Unit
144 Peak Information Deletion Processing Unit

1-12. (canceled)

13. A chromatograph input device, comprising:
a display having a touchscreen display monitor;
a display processing unit configured to have a chromatogram displayed on the display monitor;
a storage configured to store at least a data piece of a peak start point, a peak end point, a peak top, or a boundary point or a boundary line between consecutive peaks on the chromatogram, as peak information; and
a selection processing unit configured to select any of the at least one peak information piece or any peak included in the chromatogram, based on a location of a touch gesture to the chromatogram displayed on the display monitor, wherein
the selection processing unit selects a peak when the location of the touch is included in a region remote from the peak information by a certain distance or larger and remote from the chromatogram by less than a certain distance.

14. The chromatograph input device of claim 13, further comprising:
an arithmetic processing unit configured to, when the selection processing unit selects any peak included in the chromatogram, compute a height or an area of the peak.

15. The chromatograph input device of claim 13, further comprising:
a baseline creation processing unit configured to, when the selection processing unit selects peak information of a peak start point, a peak end point, or a boundary point between consecutive peaks, create data of a baseline, in response to a touch gesture to the chromatogram displayed on the display monitor.

16. The chromatograph input device of claim 15, further comprising:
an arithmetic processing unit configured to compute a height or an area of a peak based on the data of the baseline created by the baseline creation processing unit.

17. The chromatograph input device of claim 13, further comprising:
a peak separation processing unit configured to, when the selection processing unit selects peak information of a boundary point or a boundary line between consecutive peaks, separate the consecutive peaks from each other by the boundary point or the boundary line, in response to a touch gesture to the chromatogram displayed on the display monitor.

18. The chromatograph input device of claim 17, further comprising:
an arithmetic processing unit configured to compute a height or an area of a peak separated by the peak separation processing unit.

19. The chromatograph input device of claim 13, further comprising:
a peak integration processing unit configured to, when the selection processing unit selects peak information of a boundary point or a boundary line between consecutive peaks, integrate the consecutive peaks separated by the boundary point or the boundary line, in response to a touch gesture to the chromatogram displayed on the display monitor.

20. The chromatograph input device of claim 19, further comprising:
an arithmetic processing unit configured to compute a height or an area of a peak integrated by the peak integration processing unit.

21. The chromatograph input device of claim 13, further comprising:
a peak information rewriting processing unit configured to, when the selection processing unit selects peak information of a peak start point, a peak end point, a peak top, or a boundary point or a boundary line between consecutive peaks, rewrite peak information stored in the storage, in response to a touch gesture to the chromatogram displayed on the display monitor.

22. The chromatograph input device of claim 21, further comprising:
an arithmetic processing unit configured to compute a height or an area of a peak based on the peak information rewritten by the peak information rewriting processing unit.

23. The chromatograph input device of claim 13, further comprising:
a peak information deletion processing unit configured to, when the selection processing unit selects any peak included in the chromatogram, delete peak information of the peak stored in the storage, in response to a touch gesture to the chromatogram displayed on the display monitor.

24. A chromatograph comprising:
the chromatograph input device of claim 13; and
a body including the chromatograph input device.
